(19) United States
(12) Patent Application Publication
(10) Pub. No.: US 2026/0215360 A1
(43) Pub. Date: Jul. 30, 2026

(54) SIMPLIFIED NITROGEN FERTILIZER RATE RECOMMENDATION METHOD BASED ON NITROGEN BALANCE BENCHMARK

(71) Applicant: Institute of Agricultural Resources and Regional Planning,CAAS, Beijing (CN)

(72) Inventors: Wencheng DING, Beijing (CN); Ping HE, Beijing (CN); Xinpeng XU, Beijing (CN); Wei ZHOU, Beijing (CN); Shicheng ZHAO, Beijing (CN); Shaojun QIU, Beijing (CN)

(21) Appl. No.: 19/563,198

(22) Filed: Mar. 11, 2026

Related U.S. Application Data
(63) Continuation of application No. PCT/CN2025/145413, filed on Dec. 25, 2025.

(30) Foreign Application Priority Data
Jan. 24, 2025 (CN) 202510116980.X
Jan. 24, 2025 (CN) 202510117047.4
Jan. 24, 2025 (CN) 202510117133.5

(51) Int. Cl. A01C 21/00

(52) U.S. Cl. CPC A01C 21/007

(57) ABSTRACT

A simplified nitrogen fertilizer rate recommendation method based on a nitrogen balance benchmark for rice, maize and rice is provided. The present disclosure provides a nitrogen fertilizer rate recommendation method based on nitrogen balance benchmark. This method only requires knowledge of the crop yield and soil fertility level to recommend nitrogen fertilizer application rates.

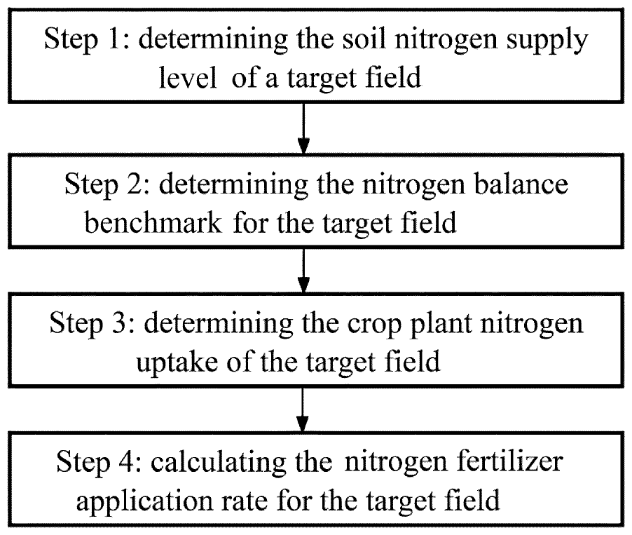

### CROSS-REFERENCE TO RELATED APPLICATIONS

This application is a continuation of International Patent Application No. PCT/CN2025/145413, filed on Dec. 25, 2025, and claims priority of Chinese Patent Application No. 202510117047.4, Chinese Patent Application No. 202510117133.5, and Chinese Patent Application No. 202510116980.X, each filed on Jan. 24, 2025. The contents of International Patent Application No. PCT/CN2025/145413 and Chinese Patent Application No. 202510117047.4, Chinese Patent Application No. 202510117133.5, and Chinese Patent Application No. 202510116980.X are hereby incorporated by reference.

### TECHNICAL FIELD

The present disclosure relates to the field of agricultural resources and environmental technology, and in particular to a simplified nitrogen fertilizer rate recommendation method based on a nitrogen balance benchmark.

### BACKGROUND

Wheat, rice, and maize, as staple crops worldwide, commonly face the problem of excessive nitrogen fertilizer application during their cultivation. Excessive nitrogen fertilizer application not only wastes fertilizer resources but also induces a series of environmental issues, such as increased ammonia volatilization, greenhouse gas emissions, leaching, and runoff losses, aggravating global atmospheric and water pollution.

Currently, crop nitrogen fertilizer recommendation methods are primarily developed based on soil nutrient testing, fertilizer response functions, and crop or soil models. However, these methods have evident limitations. On one hand, under smallholder farming practices, most farmers lack the professional equipment, technical expertise, and financial investment required for soil testing-based fertilization. Moreover, issues such as tight cropping gap in double or triple cropping systems lead to untimely soil test results. On the other hand, farmers' long-term reliance on experience-based fertilization results in widespread irrational fertilization practices, leading to low nitrogen use efficiency and prominent pressure for fertilizer reduction and emission mitigation.

Therefore, developing a crop nitrogen fertilizer recommendation method that is scientifically sound, simple to use and suitable for diverse planting scenarios has become an urgent need to promote efficient nitrogen fertilizer use and ensure the green development of agriculture.

### SUMMARY

The objective of the present disclosure is to provide a simplified nitrogen fertilizer rate recommendation method based on a nitrogen balance benchmark, to solve the problems described above.

To achieve the aforementioned objective, the present disclosure provides the following scheme.

The present disclosure provides a simplified nitrogen fertilizer rate recommendation method based on a nitrogen balance benchmark, including the following steps:

step 1: determining the soil nitrogen supply level of a target field: in nitrogen fertilizer recommendation, soil fertility is primarily manifested as the soil's nitrogen supply capacity.

The present disclosure provides four methods for determining the soil nitrogen supply level:

Method 1: determination is made according to the aboveground nitrogen uptake of the crop under a nitrogen omission treatment on the target field.

The disclosure collects and summarizes the field experiment data of fertilization carried out in the main production areas of rice, corn, and wheat in China, and establishes a database. The top 25 percent (%), middle 25%-75%, and bottom 25% of the data set of above-ground nitrogen uptake of the above crops without nitrogen fertilizer application in the database are used as the classification benchmarks for high, medium, and low soil nitrogen supply levels (Table 1, Table 2, and Table 3);

TABLE 1

| | Aboveground nitrogen uptake of rice under nitrogen | | | |
|---|---|---|---|---|
| Soil | omission treatment (kilograms per hectare (kg/ha)) | | | |
| nitrogen supply | Single- | Middle- | | |
| capacity level | season rice | season rice | Early rice | Late rice |
| Low | ≤58.2 | ≤78.3 | ≤61.2 | <65.4 |
| Medium | 58.2-89.0 | 78.3-109.9 | 61.2-96.0 | 65.4-100.2 |
| High | ≥89.0 | ≥109.9 | ≥96.0 | ≥100.2 |

TABLE 2

| | |
|---|---|
| | Aboveground nitrogen uptake |
| Soil | of maize under nitrogen |
| nitrogen supply | omission treatment (kg/ha) |

| capacity level | Spring maize | Summer maize |
|---|---|---|
| Low | <71.1 | <73.1 |
| Medium | 71.1-141.7 | 73.1-146.1 |
| High | >141.7 | >146.1 |

TABLE 3

| | |
|---|---|
| | Aboveground nitrogen uptake |
| | of wheat under nitrogen |
| Soil | omission treatment (kg/ha) |

| nitrogen supply | Northern | Southern |
|---|---|---|
| capacity level | planting region | planting region |
| Low | <49.6 | <32.1 |
| Medium | 49.6-139.2 | 32.1-93.5 |
| High | >139.2 | >93.5 |

Method 2: determination is made according to the crop yield under a nitrogen omission treatment on the target field.

Based on the database from Method 1, the first 25%, middle 25%-75%, and last 25% of the dataset of crop yield under nitrogen omission treatment are used as the criteria for dividing soil nitrogen supply into high, medium, and low levels (Table 4, Table 5, and Table 6);

TABLE 4

| | Rice yield under nitrogen | | | |
|---|---|---|---|---|
| Soil | omission treatment (kg/ha) | | | |
| nitrogen supply | Single- | Middle- | | |
| capacity level | season rice | season rice | Early rice | Late Rice |
| Low | ≤4631 | ≤5451 | ≤4167 | ≤4441 |
| Medium | 4631-6334 | 5451-6860 | 4167-6067 | 4441-6459 |
| High | ≥6334 | ≥6860 | ≥6067 | ≥6459 |

TABLE 5

| | |
|---|---|
| Soil | Maize yield under nitrogen |
| nitrogen supply | omission treatment (kg/ha) |

| capacity level | Spring maize | Summer maize |
|---|---|---|
| Low | <4300 | <3738 |
| Medium | 4300-8766 | 3738-7485 |
| High | >8766 | >7485 |

TABLE 6

| | Wheat yield under nitrogen omission | |
|---|---|---|
| Soil nitrogen supply | treatment (kg/ha) | |
| capacity level | Northern planting region | Southern planting region |
| Low | <1701 | <1098 |
| Medium | 1701-5224 | 1098-3585 |
| High | >5224 | >3585 |

Method 3: if the target field possesses soil test results, determination is made according to the soil organic matter content (Table 7); specifically:

the soil nitrogen supply level uses the soil organic matter content level as the basis for judging the nitrogen supply level, with soil hydrolysable nitrogen as an adjustment factor: when soil hydrolysable nitrogen is ≥180 milligrams of nitrogen per kilogram (mg N/kg), the soil nitrogen supply level of low supply capacity is adjusted to medium supply capacity; when soil hydrolysable nitrogen is ≤100 mg N/kg, the soil nitrogen supply level of high supply capacity is adjusted to medium supply capacity;

TABLE 7

| | | Soil hydrolysable nitrogen |
|---|---|---|
| Soil nitrogen | Soil organic matter | content (milligrams of |
| supply | content (grams per | nitrogen per kilogram |
| capacity level | kilogram (g/kg)) | (mg N/kg)) |
| Low | <10 | ≤100 |
| Medium | 10-30 | 100-180 |
| High | >30 | >180 |

Method 4: determination is made according to apparent characteristics such as soil texture and color of the target field (Table 8).

TABLE 8

| Soil nitrogen supply | |
|---|---|
| capacity level | Conditions to be met |
| Medium | Soil texture: loam or clay; |
| | Soil color: gray or brown |
| High | Soil texture: loam or clay; |
| | Soil color: black |
| Low | The above conditions are not met (sandy soil |
| | or red/yellow soil with clayey/loamy texture) |

Step 2: determining the nitrogen balance benchmark for the target field.

Based on the aforementioned database, the present disclosure establishes the relationship between the nitrogen-induced yield response (i.e., the crop yield increment of the nitrogen-fertilized treatment compared to the nitrogen omission treatment on the target field) and the soil apparent nitrogen balance (i.e., the difference between nitrogen application rate and crop uptake amount). On the basis of ensuring crop yield and minimizing nitrogen surplus in the soil to the greatest extent, a maximum economic benefit algorithm is utilized to propose nitrogen balance benchmarks under high, medium, and low soil nitrogen supply levels.

Meanwhile, the present disclosure compares the differences in soil apparent nitrogen balance between conventional nitrogen fertilizer application and fertilization modes such as controlled-release nitrogen fertilizer, mechanical deep placement of nitrogen fertilizer, nitrogen fertilizer application via organic sources, and straw return, thereby proposing reference benchmarks for nitrogen balance under different fertilization modes (Table 5).

According to the soil nitrogen supply level and the nitrogen fertilizer application mode identified in Step 1, the nitrogen balance benchmark for the target field is determined by referring to Table 9, Table 10, and Table 11.

TABLE 9

| | Rice field soil nitrogen balance benchmark | | | | |
|---|---|---|---|---|---|
| | (kg/ha) | | | | |
| Soil | | | Mechanical | Nitrogen | |
| nitrogen | Conventional | Controlled- | deep | fertilizer | |
| supply | chemical | release | placement | application | |
| capacity | nitrogen | nitrogen | of nitrogen | via organic | Straw |
| level | fertilizer | fertilizer | fertilizer | sources | return |
| Low | 88.6 | 78.6 | 71.8 | 86.8 | 82.3 |
| Medium | 63.9 | 53.9 | 47.2 | 62.1 | 57.6 |
| High | 27.9 | 18.0 | 11.2 | 26.1 | 21.6 |

TABLE 10

| | Maize field soil nitrogen balance benchmark (kg/ha) | | | | |
|---|---|---|---|---|---|
| Soil | | | Mechanical | Nitrogen | |
| nitrogen | Conventional | Controlled- | deep | fertilizer | |
| supply | chemical | release | placement | application | |
| capacity | nitrogen | nitrogen | of nitrogen | via organic | Straw |
| level | fertilizer | fertilizer | fertilizer | sources | return |
| Low | 73.3 | 61.9 | 57.5 | 73.1 | 62.7 |
| Medium | 46.4 | 35.0 | 30.6 | 46.2 | 35.8 |
| High | 12.0 | 0.6 | −3.8 | 11.8 | 1.4 |

TABLE 11

| | Wheat field soil nitrogen balance benchmark (kg/ha) | | | | |
|---|---|---|---|---|---|
| Soil | | | Mechanical | Nitrogen | |
| nitrogen | Conventional | Controlled- | deep | fertilizer | |
| supply | chemical | release | placement of | application | |
| capacity | nitrogen | nitrogen | nitrogen | via organic | Straw |
| level | fertilizer | fertilizer | fertilizer | sources | return |
| Low | 72.3 | 61.4 | 62.9 | 74.8 | 63.5 |
| Medium | 33.6 | 22.7 | 24.2 | 36.1 | 24.8 |
| High | −23.3 | −34.2 | −32.7 | −20.8 | −32.1 |

Step 3: determining the crop nitrogen uptake of the target field:

the aboveground nitrogen uptake of the crop considers both grain nitrogen uptake and straw nitrogen uptake, which may be calculated by formula (1):

$${N}_{uptake} = {N}_{grain} + {N}_{straw} = {Y}_{grain} * {X}_{grain} + {Y}_{straw} * {X}_{straw} ; \qquad ( 1 )$$

where, Nᵤₚₜₐₖₑ, N_{grain}, and N_{straw} represent the aboveground nitrogen uptake, grain nitrogen uptake, and straw nitrogen uptake (kg/ha) of the crop in the target field, respectively; Y_{grain} and Y_{straw} represent the crop grain yield and straw biomass (kg/ha), respectively; X_{grain} and X_{straw} represent the crop grain nitrogen content and crop straw nitrogen content (mg/kg), respectively.

Specifically, Y_{grain} is determined according to the average crop yield of the target field without biological stress over the past 3-5 years.

If Y_{straw} lacks measured data, it is obtained by formula (2):

$${Y}_{straw} = {Y}_{grain} * a ; \qquad ( 2 )$$

where, a represents a conversion coefficient between crop grain yield and crop straw biomass, with reference values shown in Table 12, Table 13, and Table 14.

If X_{grain} lacks measured data, then N_{grain} is obtained by formula (3):

$${N}_{grain} = {Y}_{grain} * b * 0.001 ; \qquad ( 3 )$$

where, b represents a conversion coefficient between crop grain yield and crop grain nitrogen uptake, with reference values shown in Table 12, Table 13, and Table 14.

If X_{straw} lacks measured data, then N_{straw} is obtained by formula (4):

$${N}_{straw} = {Y}_{straw} * c * 0.001 ; \qquad ( 4 )$$

where, c represents a conversion coefficient between crop straw biomass and crop straw nitrogen uptake, with reference values shown in Tables 12, Table 13, and Table 14.

TABLE 12

| | Single- | | Middle- | | | | | |
|---|---|---|---|---|---|---|---|---|
| Conversion | season | | season | | | | | |
| coefficient | rice | | rice | | Early rice | | Late rice | |
| a | 0.90 | (964) | 1.00 | (3307) | 0.88 | (1137) | 0.94 | (1126) |
| b | 9.0 | (1572) | 11.8 | (2631) | 11.9 | (1351) | 11.5 | (1270) |
| c | 5.5 | (1412) | 6.5 | (2135) | 7.8 | (1222) | 7.5 | (1168) |

Note:
the numbers in parentheses are the sample sizes.

TABLE 13

| Conversion coefficient | Spring maize | Summer maize |
|---|---|---|
| a | 1.08 | 0.95 |
| b | 10.7 | 11.9 |
| c | 5.6 | 7.5 |

TABLE 14

| Conversion | Wheat-northern planting | |
|---|---|---|
| coefficient | region | Wheat-southern planting region |
| a | 1.20 | 1.18 |
| b | 19.8 | 18.9 |
| c | 5.6 | 5.5 |

Step 4: calculating the nitrogen fertilizer application rate for the target field: the recommended nitrogen fertilizer application rate is predicted based on the aboveground nitrogen uptake of the crop and the nitrogen balance benchmark of the target field, which is specifically obtained by formula (5):

$$N = {N}_{uptake} + {N}_{balance} ; \qquad ( 5 )$$

where, N represents the recommended nitrogen fertilizer application rate (kg/ha) for the target field; Nᵤₚₜₐₖₑ represents the aboveground nitrogen uptake (kg/ha) of the crop in the target field, obtained from Step 3; N_{balance} represents the nitrogen balance benchmark (kg/ha) of the target field, obtained from Steps 1 and 2.

The nitrogen fertilizer dosage recommendation method based on the nitrogen balance benchmark of the present disclosure is a simplified recommendation method that may be used with or without soil test results. Farmers with basic scientific knowledge only need to know the yield level of the target field, identify the soil fertility level, and then go through a simple calculation process to achieve reliable nitrogen fertilizer recommendation. Compared with the prior art, it is more suitable for use by smallholders who lack the conditions for soil testing or other fertilization techniques requiring professional testing equipment and personnel.

The present disclosure not only provides nitrogen balance benchmark parameters for conventional nitrogen fertilizer application but also conducts parameter calibration for other fertilization scenarios such as controlled-release fertilizers, mechanical deep placement of nitrogen fertilizer, nitrogen fertilizer application via organic sources, and straw return. Therefore, compared with existing techniques, the present disclosure is more applicable to the current diverse crop nitrogen fertilizer application scenarios.

The present disclosure generates relevant nitrogen fertilizer recommendation parameters based on big data from field trials, rather than based on individual or a few trial results, thus having broad representativeness. Meanwhile, the present disclosure uses crop yield response as the indicator for nitrogen balance changes, instead of directly using crop yield. This is because yield response is the yield increment of the nitrogen-fertilized treatment relative to the nitrogen omission treatment, and the yield under the nitrogen omission treatment represents the soil fertility level of the plot, thereby minimizing the deviation of parameters used for fertilizer recommendation Therefore, the nitrogen balance benchmark provided by the present disclosure is suitable for different crop types, varieties, and soil-climate conditions.

The method of the present disclosure only requires knowledge of crop yield and soil fertility level to recommend nitrogen fertilizer application rates based on relevant parameters, and is applicable to different nitrogen fertilizer application scenarios such as conventional nitrogen fertilizer, controlled-release fertilizer, mechanical deep placement of nitrogen fertilizer, nitrogen fertilizer application via organic sources, and straw return. Based on the practice results of recommended fertilization using extensive field trial data from different rice planting regions, the nitrogen fertilizer application rates recommended by the method of the present disclosure are generally comparable to those recommended by soil testing and formulated fertilization but with less data and technical input, which are significantly lower compared to farmers' conventional fertilization practices. This achieves the goal of simplified and scientific fertilization, and is particularly suitable for use by smallholders who lack the conditions for soil testing and other scientific fertilization techniques.

The present disclosure discloses the following technical effects.

The present disclosure provides a crop nitrogen fertilizer dosage recommendation method based on a nitrogen balance benchmark. This method only requires knowledge of crop yield and soil fertility level to recommend nitrogen fertilizer application rates. It may ensure crop yield while minimizing nitrogen surplus in the soil to the greatest extent, thereby reducing the environmental loss of reactive nitrogen and promoting the high-yield, high-efficiency, and sustainable healthy development of agriculture.

### BRIEF DESCRIPTION OF THE DRAWING

The FIGURE is a flowchart illustrating a simplified nitrogen fertilizer rate recommendation method based on a nitrogen balance benchmark provided by the present disclosure.

### DETAILED DESCRIPTION OF THE EMBODIMENTS

Various exemplary embodiments of the present disclosure are now described in detail. This detailed description should not be considered as limiting the present disclosure, but rather as providing a more detailed description of certain aspects, features, and embodiments of the present disclosure.

It should be understood that the terms used in the present disclosure are only for describing specific embodiments and are not intended to limit the present disclosure. Furthermore, for numerical ranges in the present disclosure, it should be understood that each intermediate value between the upper and lower limits of the range is specifically disclosed as well. Every smaller range between any stated value or intermediate value within a stated range, and any other stated value or intermediate value within the range, is also encompassed within the present disclosure. The upper and lower limits of these smaller ranges may independently be included or excluded from the range.

Unless otherwise indicated, all technical and scientific terms used herein have the same meaning as commonly understood by one of ordinary skill in the art to which this disclosure belongs. Although only preferred methods and materials are described herein, any methods and materials similar or equivalent to those described herein may also be used in the practice or testing of the present disclosure. All publications cited in this specification are incorporated by reference to disclose and describe the methods and/or materials related to the publications. In the event of conflict with any incorporated publication, the content of this specification shall prevail.

Various modifications and variations to the specific embodiments described in the specification of the present disclosure may be made without departing from the scope or spirit of the present disclosure, which will be obvious to those skilled in the art. Other embodiments obtained from the description of the present disclosure will be obvious to those skilled in the art. The specification and examples of the present disclosure are exemplary only.

Regarding the terms “comprising”, “including”, “having”, “containing”, etc., used herein, they are open-ended terms, meaning including but not limited to.

It should be pointed out that operational details not described in detail herein are conventional means in the field and are not the focus of the present disclosure.

### Embodiment 1

To verify the feasibility of applying the nitrogen fertilizer dosage recommendation method based on the nitrogen balance benchmark to rice, the present disclosure conducts recommendation fertilization practices using extensive field trial data from different rice regions, and compares the results with those from local farmers' conventional fertilization and other widely recognized scientific fertilization methods to verify the reasonableness of the recommendation results.

Field trials are conducted from 2017 to 2020 in single-season rice production regions of Heilongjiang and Jilin provinces, middle-season rice production regions of Hubei and Anhui provinces, and early/late double-cropping rice production regions of Hunan and Jiangxi provinces. A total of 136 trial plots are used to verify the nitrogen fertilizer dosage recommendation method based on the nitrogen balance benchmark. The number of trials and regions for different fertilization methods are shown in Table 15. According to the aboveground nitrogen uptake of rice under the nitrogen omission treatment for each trial plot, the soil nitrogen supply level of the plot is determined using the criteria provided in Table 1 (see Table 15). According to the fertilization method and soil nitrogen supply level of each trial plot, the nitrogen balance benchmark of the plot is determined using the criteria provided in Table 9 (see Table 15). The measured value of the highest aboveground nitrogen uptake of rice among all treatments is taken as the target nitrogen uptake. The recommended nitrogen fertilizer application rates based on nitrogen balance benchmark method (referred to as NB) for these rice fields are predicted using Formula (5). The FIGURE shows the decision process of nitrogen fertilizer application rate through NB method. To check the accuracy of nitrogen fertilizer application rates through NB method, they are compared with the local farmers' nitrogen fertilizer application rates (referred to as FP), the nitrogen fertilizer application rates based on Soil Testing and Formulated Fertilization method (referred to as ST), and nitrogen fertilizer application rates based the Nutrient Expert method (referred to as NE) (see Table 16).

TABLE 15

| | Aboveground | | | |
|---|---|---|---|---|
| | nitrogen | | | |
| | uptake of | | | |
| | rice under | | | |
| | nitrogen | | | |
| | omission | | | |
| | treatment | Soil | | |
| | (kilograms | nitrogen | | |
| Fertilization | per hectare | supply | Number | Trial |
| method | (kg/ha)) | level | of trials | provinces |
| Conventional | 51.6-72.5 | Low | 36 | Heilongjiang, |
| chemical | 63.2-95.7 | Medium | 40 | Jilin, Hubei, |
| nitrogen | 97.2-130.5 | High | 13 | Anhui, |
| fertilizer | | | | Hunan, |
| | | | | Jiangxi |
| Controlled-release | 51.6-66.5 | Low | 6 | Heilongjiang, |
| nitrogen fertilizer | 63.2-88.6 | Medium | 7 | Jilin, Hubei, |
| | 99.2-110.2 | High | 3 | Hunan |
| Mechanical deep | 59.3 | Low | 1 | Jiangxi |
| placement of | 72.5 | Medium | 1 | |
| nitrogen fertilizer | | | | |
| Nitrogen fertilizer | 55.3-66.5 | Low | 6 | Hubei, |
| application via | 73.5-88.6 | Medium | 7 | Anhui, |
| organic sources | 112.2 | High | 1 | Hunan, |
| | | | | Jiangxi |
| Straw return | 57.3-67.4 | Low | 2 | Hubei, |
| | 72.5-91.3 | Medium | 11 | Anhui, |
| | 99.4-110.3 | High | 2 | Hunan, |
| | | | | Jiangxi |

TABLE 16

| | Recommendation process and results of the | | | | | | | |
|---|---|---|---|---|---|---|---|---|
| | present disclosure | | | | Recommendation results of other methods | | | |
| | Soil | Nitrogen | Target | NB | FP nitrogen | ST | NE | |
| | nitrogen | balance | nitrogen | recommended | application | recommended | recommended | |
| | supply | standard | uptake | nitrogen rate | rate | nitrogen rate | nitrogen rate | Number |
| Rice type | grade | (kg/ha) | (kg/ha) | (kg/ha) | (kg/ha) | (kg/ha) | (kg/ha) | of trials |
| Single-season | Low | 78.6-88.6 | 96.2 | 185 | 194 | 178 | 161 | 12 |
| rice | Medium | 53.9-63.9 | 105.3 | 169 | 180 | 175 | 164 | 26 |
| | High | 18.0-27.9 | 132.0 | 160 | 177 | 170 | 167 | 8 |
| Middle-season | Low | 78.6-88.6 | 114.4 | 203 | 179 | 170 | 158 | 5 |
| rice | Medium | 53.9-63.9 | 122.1 | 186 | 193 | 169 | 162 | 14 |
| | High | 18.0-27.9 | 137.7 | 166 | 199 | 186 | 158 | 6 |
| Early rice | Low | 71.8-88.6 | 107.4 | 196 | 161 | 143 | 152 | 28 |
| | Medium | 47.2-63.9 | 123.3 | 187 | 178 | 151 | 141 | 3 |
| | High | 11.2-27.9 | 139.6 | 168 | 186 | 162 | 146 | 3 |
| Late rice | Low | 71.8-88.6 | 116.4 | 205 | 171 | 184 | 150 | 6 |
| | Medium | 47.2-63.9 | 128.1 | 192 | 206 | 179 | 144 | 23 |
| | High | 11.2-27.9 | 156.9 | 185 | 243 | 165 | 144 | 2 |

Table 16 classifies and summarizes the average nitrogen fertilizer application rates of the four fertilization methods on rice fields under same rice type region and soil fertility level. The results show that for single-season rice, the average NB nitrogen application rate under the three soil fertility levels (high, medium, low) is 171 kg/ha, which is 6.7 percent (%) lower than the average FP nitrogen application rate, and is generally comparable to the ST recommendation results. For middle-season rice, the average NB rate under the three soil fertility levels is 185 kg/ha, which is 2.8% lower than the average FP nitrogen application rate but higher compared to the ST and NE rates. This is mainly due to the higher recommendation results of the method of the present disclosure on low-fertility soils to ensure the target yield level. For early rice and late rice, the average NB rates are 184 kg/ha and 194 kg/ha, respectively. The NB application rate for late rice is lower than the FP application rate, while the NB application rate for early rice is higher than the FP rate, also manifested in higher recommendation results for low-fertility soils.

### Embodiment 2

To verify the feasibility of applying the nitrogen fertilizer dosage recommendation method based on the nitrogen balance benchmark to maize, the present disclosure conducts recommendation fertilization practices using extensive field trial data from different maize planting season types, and compares the results with those from local farmers' conventional fertilization and other widely recognized scientific fertilization methods to verify the reasonableness of the recommendation results.

Field trials are conducted from 2017 to 2020 in main spring maize production regions such as Heilongjiang, Jilin, and Inner Mongolia, and in main summer maize production provinces such as Hebei and Shanxi. A total of 124 trial plots are used to verify the nitrogen fertilizer dosage recommendation method based on the nitrogen balance benchmark. The number of trials and regions for different fertilization methods are shown in Table 17. According to the aboveground nitrogen uptake of maize under the nitrogen omission treatment for each trial plot (Table 17), the soil nitrogen supply level of the plot is determined using the criteria provided in Table 2 (see Table 17). According to the fertilization method and soil nitrogen supply level of each trial plot, the nitrogen balance benchmark of the plot is determined using the criteria provided in Table 10 (see Table 18). The measured value of the highest aboveground nitrogen uptake of maize among all treatments is taken as the target nitrogen uptake. The recommended nitrogen fertilizer application rates based on nitrogen balance benchmark method (referred to as NB) for these rice fields are predicted using Formula (5) and compared with the local farmers' nitrogen fertilizer application rates (referred to as FP), the nitrogen fertilizer application rates based on Soil Testing and Formulated Fertilization method (referred to as ST), and nitrogen fertilizer application rates based the Nutrient Expert method (referred to as NE) (see Table 18).

TABLE 17

| | Aboveground | | | |
|---|---|---|---|---|
| | nitrogen | | | |
| | uptake of | | | |
| | maize under | | | |
| | nitrogen | Soil | | |
| | omission | nitrogen | | |
| Fertilization | treatment | supply | Number | |
| method | (kg/ha) | level | of trials | Trial regions |
| Conventional | 45.5-70.3 | Low | 10 | Heilongjiang, |
| chemical nitrogen | 78.1-139.6 | Medium | 36 | Jilin, Inner |
| fertilizer | 148.7-200.5 | High | 30 | Mongolia, |
| | | | | Hebei, |
| | | | | Shanxi |
| Controlled-release | 68.5 | Low | 1 | Heilongjiang, |
| nitrogen fertilizer | 78.1-139.6 | Medium | 10 | Jilin, Hebei, |
| | 148.7-200.5 | High | 10 | Shanxi |
| Mechanical deep | 62.3 | Low | 1 | Heilongjiang, |
| placement of | 168.0 | Medium | 1 | Hebei |
| nitrogen fertilizer | | | | |
| Nitrogen fertilizer | 68.5 | Low | 1 | Jilin, Inner |
| application via | 78.1-139.6 | Medium | 7 | Mongolia, |
| organic sources | 148.7-200.5 | High | 5 | Hebei |
| Straw return | 78.1-139.6 | Medium | 5 | Jilin, Inner |
| | 148.7-200.5 | High | 7 | Mongolia, |
| | | | | Hebei |

TABLE 18

| | Recommendation process and results of | | | | Recommendation results of other methods | | | |
|---|---|---|---|---|---|---|---|---|
| | the present disclosure | | | | FP | | | |
| | Soil | Nitrogen | Target | NB | nitrogen | ST | NE | |
| | nitrogen | balance | nitrogen | recommended | application | recommended | recommended | |
| Maize | supply | standard | uptake | nitrogen rate | rate | nitrogen rate | nitrogen rate | Number of |
| type | grade | (kg/ha) | (kg/ha) | (kg/ha) | (kg/ha) | (kg/ha) | (kg/ha) | trials |
| Spring | Low | 57.5-73.3 | 152.1 | 225 | 242 | 191 | 202 | 10 |
| maize | Medium | 30.6-46.4 | 174.2 | 221 | 231 | 206 | 207 | 42 |
| | High | 0.6-12.0 | 203.0 | 215 | 233 | 188 | 200 | 39 |
| Summer | Low | 61.9-73.3 | 97.6 | 171 | 182 | 171 | 215 | 3 |
| maize | Medium | 35.0-46.4 | 145.0 | 191 | 242 | 173 | 217 | 17 |
| | High | 0.6-12.0 | 181.5 | 194 | 278 | 161 | 199 | 13 |

Table 18 classifies and summarizes the maize nitrogen demand and the recommended application rates of the four fertilization methods on plots of different maize planting season types and different soil fertility levels. The results show that on all plots of spring maize, the average NB nitrogen application rate is 220 kg/ha, which is 6.4% lower than the average FP nitrogen application rate, but 8.6% to 13.1% higher compared to the ST and NE recommendation results. This is mainly due to the lower inherent nitrogen supply capacity of low-fertility soils; to ensure the yield level, the method of the present disclosure requires a higher external nitrogen fertilizer input. On all plots of summer maize, the average NB nitrogen application rate is 185 kg/ha, which is essentially the median of the recommendations from the ST and NE methods, and is 20.8% lower than the average FP nitrogen application rate.

### Embodiment 3

To verify the feasibility of applying the nitrogen fertilizer dosage recommendation method based on the nitrogen balance benchmark to wheat, the present disclosure conducts recommendation fertilization practices using extensive field trial data from main wheat production regions in China, and compares the results with those from local farmers' conventional fertilization and other widely recognized scientific fertilization methods to verify the reasonableness of the recommendation results.

Field trials are conducted from 2017 to 2020 in major wheat-producing provinces such as Henan, Shandong, Hebei, Shanxi, and Inner Mongolia. A total of 44 trial plots are used to verify the nitrogen fertilizer dosage recommendation method based on the nitrogen balance benchmark. The number of trials and regions for different fertilization methods are shown in Table 19. According to the aboveground nitrogen uptake of wheat under the nitrogen omission treatment for each trial plot, the soil nitrogen supply level of the plot is determined using the criteria provided in Table 3 (see Table 19). According to the fertilization method and soil nitrogen supply level of each trial plot, the nitrogen balance benchmark of the plot is determined using the criteria provided in Table 11 (see Table 20). The measured value of the highest aboveground nitrogen uptake of wheat among all treatments is taken as the target nitrogen uptake. The recommended nitrogen fertilizer application rates based on nitrogen balance benchmark method (referred to as NB) for these rice fields are predicted using Formula (5) and compared with the local farmers' nitrogen fertilizer application rates (referred to as FP), the nitrogen fertilizer application rates based on Soil Testing and Formulated Fertilization method (referred to as ST), and nitrogen fertilizer application rates based the Nutrient Expert method (referred to as NE) (see Table 20).

TABLE 19

| | Aboveground | | | |
|---|---|---|---|---|
| | nitrogen | | | |
| | uptake of | | | |
| | wheat | | | |
| | under | | | |
| | nitrogen | Soil | | |
| | omission | nitrogen | Number | |
| Fertilization | treatment | supply | of | Trial |
| method | (kg/ha) | level | trials | provinces |
| Conventional | 41.5-49.2 | Low | 2 | Henan, |
| chemical nitrogen | 52.0-135.7 | Medium | 8 | Shandong, |
| fertilizer | 146.7-190.6 | High | 16 | Hebei, |
| | | | | Shanxi, Inner |
| | | | | Mongolia |
| Controlled-release | 41.5 | Low | 1 | Henan, |
| nitrogen fertilizer | 110.6 | Medium | 1 | Shandong, |
| | 146.7-190.6 | High | 6 | Hebei |
| Mechanical deep | 120.4 | Medium | 1 | Henan, Hebei |
| placement of | 168.0 | High | 1 | |
| nitrogen fertilizer | | | | |
| Nitrogen fertilizer | 41.5 | Low | 1 | Hebei, |
| application via | 110.6 | Medium | 1 | Shanxi, Inner |
| organic sources | 167.6-190.6 | High | 3 | Mongolia |
| Straw return | 113.3 | Medium | 1 | Henan, Hebei, |
| | 180.2-190.6 | High | 2 | Inner |
| | | | | Mongolia |

TABLE 20

| Recommendation process and results of the present | | | | | | | |
|---|---|---|---|---|---|---|---|
| disclosure | | | | Recommendation results of other methods | | | |
| Soil | Nitrogen | Target | NB | FP nitrogen | ST | NE nitrogen | |
| nitrogen | balance | nitrogen | recommended | application | recommended | application | |
| supply | standard | uptake | nitrogen rate | rate | nitrogen rate | rate | Number |
| grade | (kg/ha) | (kg/ha) | (kg/ha) | (kg/ha) | (kg/ha) | (kg/ha) | of trials |
| Low | 61.4-74.8 | 119 (95-133) | 191 (167-205) | 238 (227-273) | 232 (225-255) | 174 (153-238) | 4 |
| Medium | 24.2-36.1 | 187 (120-246) | 221 (155-280) | 267 (227-384) | 224 (219-255) | 197 (180-238) | 12 |
| High | −34.2-−20.8 | 208 (156-308) | 185 (133-285) | 266 (194-384) | 218 (200-255) | 178 (153-238) | 28 |
| Average | | 171 | 199 | 257 | 225 | 183 | — |

Table 20 classifies and summarizes the average nitrogen fertilizer application rates of the four fertilization methods on relevant plots of different soil fertility levels. The results show that on all trial plots, the average wheat nitrogen demand is 171 kg/ha, and the average NB nitrogen application rate is 199 kg/ha. This rate falls between the recommended values of the two scientific fertilization methods ST and NE, essentially ensuring the reasonableness of the recommendation. Compared to farmers' conventional fertilization (FP), it is reduced by 22.6%. Among these, the reduction potential of the NB nitrogen application rate compared to FP is greatest on high-fertility plots, at 30.5%. The average NB nitrogen application rates under the low, medium, and high soil fertility levels are 191 kg/ha, 221 kg/ha, and 185 kg/ha, respectively. The difference range compared to the ST recommendation method is −3 to −41 kg/ha, and the difference range compared to the NE recommendation method is 7 to 24 kg/ha.

In summary, the application of the nitrogen fertilizer dosage recommendation method based on the nitrogen balance benchmark of the present disclosure may significantly reduce the current farmers' conventional nitrogen fertilizer application rates. Under high soil fertility conditions, the recommendation results are generally comparable to those of soil testing and formulated fertilization. Under medium and low soil fertility conditions, the recommendation results are higher compared to the other two scientific fertilization methods, primarily by considering the increase in fertilizer nitrogen input to ensure the yield level of the land plot while avoiding excessive depletion of soil organic matter. Therefore, the field verification trial results indicate that the nitrogen fertilizer dosage recommendation method based on the nitrogen balance benchmark proposed by the present disclosure may be used for decision-making regarding crop nitrogen fertilizer application rates.

The embodiments described above are only for describing the optional modes of the present disclosure and are not intended to limit the scope of the present disclosure. Without departing from the design spirit of the present disclosure, various modifications and improvements made by those of ordinary skill in the art to the technical solutions of the present disclosure shall fall within the scope of protection defined by the claims of the present disclosure.

What is claimed is:

1. A simplified rice nitrogen fertilizer dosage recommendation method based on a nitrogen balance benchmark, comprising following steps:
(1) determining a soil nitrogen supply level of a target field by any one of Method 1, Method 2, Method 3, or Method 4:
Method 1: determining the soil nitrogen supply level of the target field according to aboveground nitrogen uptake of rice under a nitrogen omission treatment, based on different rice varieties:

| Soil | Aboveground nitrogen uptake of | | | |
|---|---|---|---|---|
| nitrogen | rice under nitrogen omission | | | |
| supply | treatment (kilograms per hectare (kg/ha)) | | | |
| capacity | Single-season | Middle-season | | |
| level | rice | rice | Early rice | Late Rice |
| Low | <58.2 | <78.3 | <61.2 | <65.4 |
| Medium | 58.2-89.0 | 78.3-109.9 | 61.2-96.0 | 65.4-100.2 |
| High | >89.0 | >109.9 | >96.0 | >100.2 |

Method 2: determining the soil nitrogen supply level of the target field according to rice yield under the nitrogen omission treatment, based on the different rice varieties:
Soil
nitrogen

| supply | Rice yield under nitrogen omission treatment (kg/ha) | | | |
|---|---|---|---|---|
| capacity | Single-season | Middle- | Early | |
| level | rice | season rice | rice | Late Rice |
| Low | <4631 | <5451 | <4167 | <4441 |
| Medium | 4631-6334 | 5451-6860 | 4167-6067 | 4441-6459 |
| High | >6334 | >6860 | >6067 | >6459 |

Method 3: dividing the soil nitrogen supply level of the target field according to soil organic matter content:

| Soil | | |
|---|---|---|
| nitrogen | | |
| supply | Soil organic matter | Soil hydrolysable nitrogen |
| capacity | content (grams per | content (milligrams of nitrogen per |
| level | kilogram (g/kg)) | kilogram (mg N/kg)) |
| Low | <10 | <100 |
| Medium | 10-30 | 100-180 |
| High | >30 | >180 |

wherein the soil nitrogen supply level uses a soil organic matter content level as a judgment basis, with soil hydrolysable nitrogen as an adjustment factor: when the soil hydrolysable nitrogen is ≥180 milligrams per kilogram (mg/kg), the soil nitrogen supply level of the low supply capacity is adjusted to the medium supply capacity; when the soil hydrolysable nitrogen is ≤100 mg/kg, the soil nitrogen supply level of high supply capacity is adjusted to the medium supply capacity;
Method 4: determining the soil nitrogen supply level of the target field according to soil texture and apparent characteristics:

| Soil | |
|---|---|
| nitrogen supply | |
| capacity level | Conditions to be met |
| Medium | Soil texture: loam or clay; |
| | Soil color: gray or brown |
| High | Soil texture: loam or clay; |
| | Soil color: black |
| Low | The conditions above are not met |

(2) determining the nitrogen balance benchmark for the target field according to the soil nitrogen supply level of the target field determined in the step (1) and in combination with a fertilization mode, with reference to a following table:

| | Nitrogen balance benchmark (kg/ha) | | | | |
|---|---|---|---|---|---|
| | | | Mechanical | Nitrogen | |
| | Conventional | Controlled- | deep | fertilizer | |
| Soil | chemical | release | placement | application | |
| nitrogen supply | nitrogen | nitrogen | of nitrogen | via organic | Straw |
| capacity level | fertilizer | fertilizer | fertilizer | sources | return |
| Low | 88.6 | 78.6 | 71.8 | 86.8 | 82.3 |
| Medium | 63.9 | 53.9 | 47.2 | 62.1 | 57.6 |
| High | 27.9 | 18.0 | 11.2 | 26.1 | 21.6 |

(3) obtaining Y_{grain} as rice grain yield based on a target yield, and determining the aboveground nitrogen uptake of the rice for the target field according to formula (a-1) or (a-2):
$${N}_{uptake} = {N}_{grain} + {N}_{straw} ; \qquad ( a - 1 )$$
wherein:
Nᵤₚₜₐₖₑ is the aboveground nitrogen uptake of the rice, in kg/ha;
N_{grain} is a rice grain nitrogen uptake, in kg/ha; and
N_{straw} is a rice straw nitrogen uptake, in kg/ha;
$${N}_{uptake} = {Y}_{grain} * {X}_{grain} + {Y}_{straw} * {X}_{straw} ; \qquad ( a - 2 )$$
wherein:
Nᵤₚₜₐₖₑ is the aboveground nitrogen uptake of the rice, in kg/ha;
Y_{grain} is the rice grain yield, in kg/ha;
Y_{straw} is rice straw biomass, in kg/ha;
X_{grain} is a rice grain nitrogen content, in mg/kg; and
X_{straw} is a rice straw nitrogen content, in mg/kg;
(4) calculating a recommended rice nitrogen fertilizer application rate for the target field according to formula (b):
$$N = {N}_{uptake} + {N}_{balance} ; \qquad ( b )$$
wherein, N represents the recommended rice nitrogen fertilizer application rate, in kg/ha; Nᵤₚₜₐₖₑ represents the aboveground nitrogen uptake of the rice, in kg/ha; and N_{balance} represents the nitrogen balance benchmark, in kg/ha;
wherein when no measured value is available for the rice straw biomass, the rice straw biomass is calculated according to formula (c):
$${Y}_{s t r a w} = {Y}_{g r a i n} * a ; \qquad ( c )$$
wherein Y_{straw} is the rice straw biomass, in kg/ha; Y_{grain} is the rice grain yield, in kg/ha; and a represents a conversion coefficient between the rice grain yield and the rice straw biomass, wherein conversion coefficients for different rice varieties are shown in a table below;
when no measured value is available for the rice grain nitrogen uptake, the rice grain nitrogen uptake is calculated according to formula (d):
$${N}_{grain} = {Y}_{grain} * b * 0.001 \qquad ( d )$$
wherein N_{grain} is the rice grain nitrogen uptake, in kg/ha; Y_{grain} is the rice grain yield, in kg/ha; and b represents a conversion coefficient between the rice grain yield and the rice grain nitrogen uptake, wherein conversion coefficients for different rice varieties are shown in the table below;
when no measured value is available for the rice straw nitrogen uptake, the rice straw nitrogen uptake is calculated according to formula (e):
$${N}_{s t r a w} = {Y}_{s t r a w} * c * 0.001 ; \qquad ( e )$$
wherein N_{straw} is the rice straw nitrogen uptake, in kg/ha; Y_{straw} is the rice straw biomass, in kg/ha; and c represents a conversion coefficient between the rice straw biomass and the rice straw nitrogen uptake, wherein conversion coefficients for different rice varieties are shown in the table below:

| Conversion | Single- | Middle- | | |
|---|---|---|---|---|
| coefficient | season rice | season rice | Early rice | Late rice |
| a | 0.90 | 1.00 | 0.88 | 0.94 |
| b | 9.0 | 11.8 | 11.9 | 11.5 |
| c | 5.5 | 6.5 | 7.8 | 7.5 |

2. A simplified maize nitrogen fertilizer dosage recommendation method based on a nitrogen balance benchmark, comprising following steps:
(1) determining a soil nitrogen supply level of a target field by any one of Method 1, Method 2, Method 3, or Method 4:
Method 1: determining the soil nitrogen supply level of the target field according to aboveground nitrogen uptake of maize under a nitrogen omission treatment, based on different maize varieties:

| | |
|---|---|
| Soil | Aboveground nitrogen uptake of maize under |
| nitrogen supply | nitrogen omission treatment (kg/ha) |
| capacity level | Spring maize | Summer maize |
|---|---|---|
| Low | <71.1 | <73.1 |
| Medium | 71.1-141.7 | 73.1-146.1 |
| High | >141.7 | >146.1 |

Method 2: determining the soil nitrogen supply level of the target field according to maize yield under the nitrogen omission treatment, based on the different maize varieties:

| | |
|---|---|
| Soil | Maize yield under nitrogen |
| nitrogen supply | omission treatment (kg/ha) |
| capacity level | Spring maize | Summer maize |
|---|---|---|
| Low | <4300 | <3738 |
| Medium | 4300-8766 | 3738-7485 |
| High | >8766 | >7485 |

Method 3: dividing the soil nitrogen supply level of the target field according to soil organic matter content:

| Soil | Soil organic | Soil |
|---|---|---|
| nitrogen supply | matter content | hydrolysable nitrogen |
| capacity level | (g/kg) | content (mg N/kg) |
| Low | <10 | <100 |
| Medium | 10-30 | 100-180 |
| High | >30 | >180 |

wherein the soil nitrogen supply level uses a soil organic matter content level as a judgment basis, with soil hydrolysable nitrogen as an adjustment factor: when a soil hydrolysable nitrogen is ≥180 milligrams per kilogram (mg/kg), the soil nitrogen supply level of the low supply capacity is adjusted to the medium supply capacity; when the soil hydrolysable nitrogen is ≤100 mg/kg, the soil nitrogen supply level of high supply capacity is adjusted to the medium supply capacity;
Method 4: determining the soil nitrogen supply level of the target field according to soil texture and apparent characteristics:

| Soil | |
|---|---|
| nitrogen supply | |
| capacity level | Conditions to be met |
| Medium | Soil texture: loam or clay; |
| | Soil color: gray or brown |
| High | Soil texture: loam or clay; |
| | Soil color: black |
| Low | The conditions above are not met |

(2) determining the nitrogen balance benchmark for the target field according to the soil nitrogen supply level of the target field determined in the step (1) and in combination with a fertilization mode, with reference to a following table:

| | Nitrogen balance benchmark (kg/ha) | | | | |
|---|---|---|---|---|---|
| | | | Mechanical | Nitrogen | |
| | Conventional | Controlled- | deep | fertilizer | |
| Soil | chemical | release | placement | application | |
| nitrogen supply | nitrogen | nitrogen | of nitrogen | via organic | Straw |
| capacity level | fertilizer | fertilizer | fertilizer | sources | return |
| Low | 73.3 | 61.9 | 57.5 | 73.1 | 62.7 |
| Medium | 46.4 | 35.0 | 30.6 | 46.2 | 35.8 |
| High | 12.0 | 0.6 | −3.8 | 11.8 | 1.4 |

(3) obtaining Y_{grain} as maize grain yield based on a target yield, and determining the aboveground nitrogen uptake of the maize for the target field according to formula (a-1) or (a-2):
$${N}_{uptake} = {N}_{g r a i n} + {N}_{s t r a w} ; \qquad ( a - 1 )$$
wherein:
Nᵤₚₜₐₖₑ is the aboveground nitrogen uptake of the maize, in kg/ha;
N_{grain} is a maize grain nitrogen uptake, in kg/ha; and
N_{straw} is a maize straw nitrogen uptake, in kg/ha;
$${N}_{uptake} = {Y}_{grain} * {X}_{grain} + {Y}_{s t r a w} * {X}_{s t r a w} ; \qquad ( a - 2 )$$
wherein:
Nᵤₚₜₐₖₑ is the aboveground nitrogen uptake of the maize, in kg/ha;
Y_{grain} is the maize grain yield, in kg/ha;
Y_{straw} is maize straw biomass, in kg/ha;
X_{grain} is a maize grain nitrogen content, in mg/kg; and
X_{straw} is a maize straw nitrogen content, in mg/kg;
(4) calculating a recommended maize nitrogen fertilizer application rate for the target field according to formula (b):
$$N = {N}_{uptake} + {N}_{balance} ; \qquad ( b )$$
wherein, N represents the recommended maize nitrogen fertilizer application rate, in kg/ha; Nᵤₚₜₐₖₑ represents the aboveground nitrogen uptake of the maize, in kg/ha; and N_{balance} represents the nitrogen balance benchmark, in kg/ha;
wherein the maize straw biomass is calculated according to formula (c):
$${Y}_{s t r a w} = {Y}_{g r a i n} * a ; \qquad ( c )$$
wherein Y_{straw} is the maize straw biomass, in kg/ha; Y_{grain} is the maize grain yield, in kg/ha; and a represents a conversion coefficient between the maize grain yield and the maize straw biomass, wherein conversion coefficients for different maize varieties are shown in a table below;
the maize grain nitrogen uptake is calculated according to formula (d):
$${N}_{grain} = {Y}_{grain} * b * 0.001 \qquad ( d )$$
wherein N_{grain} is the maize grain nitrogen uptake, in kg/ha; Y_{grain} is the maize grain yield, in kg/ha; and b represents a conversion coefficient between the maize grain yield and the maize grain nitrogen uptake, wherein conversion coefficients for different maize varieties are shown in the table below;
the maize straw nitrogen uptake is calculated according to formula (e):
$${N}_{s t r a w} = {Y}_{s t r a w} * c * 0.001 ; \qquad ( e )$$
wherein N_{straw} is the maize straw nitrogen uptake, in kg/ha; Y_{straw} is the maize straw biomass, in kg/ha; and c represents a conversion coefficient between the maize straw biomass and the maize straw nitrogen uptake, wherein conversion coefficients for different maize varieties are shown in the table below:

| Conversion | | |
|---|---|---|
| coefficient | Spring maize | Summer maize |
| a | 1.08 | 0.95 |
| b | 10.7 | 11.9 |
| c | 5.6 | 7.5 |

3. A simplified wheat nitrogen fertilizer dosage recommendation method based on a nitrogen balance benchmark, comprising following steps:
(1) determining a soil nitrogen supply level of a target field by any one of Method 1, Method 2, Method 3, or Method 4:
Method 1: determining the soil nitrogen supply level of the target field according to aboveground nitrogen uptake of wheat under a nitrogen omission treatment, based on different wheat planting regions:

| | |
|---|---|
| | Aboveground nitrogen uptake of wheat under |
| Soil | nitrogen omission treatment (kg/ha) |
| nitrogen supply | Northern | Southern |
|---|---|---|
| capacity level | planting region | planting region |
| Low | <49.6 | <32.1 |
| Medium | 49.6-139.2 | 32.1-93.5 |
| High | >139.2 | >93.5 |

Method 2: determining the soil nitrogen supply level of the target field according to wheat yield under the nitrogen omission treatment, based on the different wheat planting regions:

| | |
|---|---|
| | Wheat yield under nitrogen |
| Soil | omission treatment (kg/ha) |
| nitrogen supply | Northern | Southern |
|---|---|---|
| capacity level | planting region | planting region |
| Low | <1701 | <1098 |
| Medium | 1701-5224 | 1098-3585 |
| High | >5224 | >3585 |

Method 3: dividing the soil nitrogen supply level of the target field according to soil organic matter content:

| Soil | Soil organic | Soil |
|---|---|---|
| nitrogen supply | matter content | hydrolysable nitrogen |
| capacity level | (g/kg) | content (mg N/kg) |
| Low | <10 | <100 |
| Medium | 10-30 | 100-180 |
| High | >30 | >180 |

wherein the soil nitrogen supply level uses a soil organic matter content level as a judgment basis, with soil hydrolysable nitrogen as an adjustment factor: when a soil hydrolysable nitrogen is ≥180 milligrams per kilogram (mg/kg), the soil nitrogen supply level of the low supply capacity is adjusted to the medium supply capacity; when the soil hydrolysable nitrogen is ≤100 mg/kg, the soil nitrogen supply level of high supply capacity is adjusted to the medium supply capacity;
Method 4: determining the soil nitrogen supply level of the target field according to soil texture and apparent characteristics:

| Soil | |
|---|---|
| nitrogen supply | |
| capacity level | Conditions to be met |
| Medium | Soil texture: loam or clay; |
| | Soil color: gray or brown |
| High | Soil texture: loam or clay; |
| | Soil color: black |
| Low | The conditions above are not met |

(2) determining the nitrogen balance benchmark for the target field according to the soil nitrogen supply level of the target field determined in the step (1) and in combination with a fertilization mode, with reference to a following table:

| | Nitrogen balance benchmark (kg/ha) | | | | |
|---|---|---|---|---|---|
| | | | Mechanical | Nitrogen | |
| | Conventional | Controlled- | deep | fertilizer | |
| Soil nitrogen | chemical | release | placement | application | |
| supply capacity | nitrogen | nitrogen | of nitrogen | via organic | Straw |
| level | fertilizer | fertilizer | fertilizer | sources | return |
| Low | 72.3 | 61.4 | 62.9 | 74.8 | 63.5 |
| Medium | 33.6 | 22.7 | 24.2 | 36.1 | 24.8 |
| High | −23.3 | −34.2 | −32.7 | −20.8 | −32.1 |

(3) obtaining Y_{grain} as wheat grain yield based on a target yield, and determining the aboveground nitrogen uptake of the wheat for the target field according to formula (a-1) or (a-2):
$${N}_{uptake} = {N}_{g r a i n} + {N}_{s t r a w} ; \qquad ( a - 1 )$$
wherein:
Nᵤₚₜₐₖₑ is the aboveground nitrogen uptake of the wheat, in kg/ha;
N_{grain} is a wheat grain nitrogen uptake, in kg/ha; and
N_{straw} is a wheat straw nitrogen uptake, in kg/ha;
$${N}_{uptake} = {Y}_{grain} * {X}_{grain} + {Y}_{s t r a w} * {X}_{s t r a w} ; \qquad ( a - 2 )$$
wherein:
Nᵤₚₜₐₖₑ is the aboveground nitrogen uptake of the wheat, in kg/ha;
Y_{grain} is the wheat grain yield, in kg/ha;
Y straw is wheat straw biomass, in kg/ha;
X_{grain} is a wheat grain nitrogen content, in mg/kg; and
X_{straw} is a wheat straw nitrogen content, in mg/kg;
(4) calculating a recommended wheat nitrogen fertilizer application rate for the target field according to formula (b):
$$N = {N}_{uptake} + {N}_{balance} ; \qquad ( b )$$
wherein, N represents the recommended wheat nitrogen fertilizer application rate, in kg/ha; Nᵤₚₜₐₖₑ represents the aboveground nitrogen uptake of the wheat, in kg/ha; and N_{balance} represents the nitrogen balance benchmark, in kg/ha;
wherein the wheat straw biomass is calculated according to formula (c):
$${Y}_{s t r a w} = {Y}_{g r a i n} * a ; \qquad ( c )$$
wherein Y_{straw} is the wheat straw biomass, in kg/ha; Y_{grain} is the wheat grain yield, in kg/ha; and a represents a conversion coefficient between the wheat grain yield and the wheat straw biomass, wherein conversion coefficients for different wheat varieties are shown in a table below;
when no measured value is available for the wheat grain nitrogen uptake, the wheat grain nitrogen uptake is calculated according to formula (d):
$${N}_{grain} = {Y}_{grain} * b * 0.001 \qquad ( d )$$
wherein N_{grain} is the wheat grain nitrogen uptake, in kg/ha; Y_{grain} is the wheat grain yield, in kg/ha; and b represents a conversion coefficient between the wheat grain yield and the wheat grain nitrogen uptake, wherein conversion coefficients for different wheat varieties are shown in the table below;
when no measured value is available for the wheat straw nitrogen uptake, the wheat straw nitrogen uptake is calculated according to formula (e):
$${N}_{s t r a w} = {Y}_{s t r a w} * c * 0.001 ; \qquad ( e )$$
wherein N_{straw} is the wheat straw nitrogen uptake, in kg/ha; Y straw is the wheat straw biomass, in kg/ha; and c represents a conversion coefficient between the wheat straw biomass and the wheat straw nitrogen uptake, wherein conversion coefficients for different wheat varieties are shown in the table below:

| Conversion | Wheat-northern | Wheat-southern |
|---|---|---|
| coefficient | planting region | planting region |
| a | 1.20 | 1.18 |
| b | 19.8 | 18.9 |
| c | 5.6 | 5.5 |
